(19) United States
(12) Patent Application Publication
(10) Pub. No.: US 2020/0025672 A1
(43) Pub. Date: Jan. 23, 2020

(54) MYCELIUM WITH REDUCED COEFFICIENT OF FRICTION AND ABRASION RESISTANCE THROUGH MECHANICAL ALTERATION OF MYCELIAL SURFACE MICROSTRUCTURE

(71) Applicant: Mycoworks, Inc., Emeryville, CA (US)

(72) Inventors: Matthew L. Scullin, San Francisco, CA (US); Jordan Chase, Oakland, CA (US); Nicholas Wenner, Sebastopol, CA (US); Quinn Miller, Berkeley, CA (US); Philip Ross, San Francisco, CA (US)

(21) Appl. No.: 16/517,416

(22) Filed: Jul. 19, 2019

Related U.S. Application Data
(60) Provisional application No. 62/700,486, filed on Jul. 19, 2018.

(51) Int. Cl. G01N 19/02

(52) U.S. Cl. CPC G01N 19/02

(57) ABSTRACT

A method for reducing and determining coefficient of friction of a mycelium for improving a plurality of mechanical properties of the mycelium. In the method, a first mycelium layer is contacted with an abrasive and pressure apparatus for smoothing and altering a microstructure of the mycelium. The smoothing of the mycelium microstructure reduces the coefficient of friction of the mycelium thereby enhancing the abrasion resistance of the mycelium. The coefficient of friction of the mycelium surface reduced through smoothing of the mycelium surface is determined utilizing a tilt angle mechanism.

### PRIORITY

This application claims priority from the U.S. provisional application Ser. No. 62/700,486, filed Jul. 19, 2018. The disclosure of that provisional application is incorporated herein by reference as if set out in full.

### BACKGROUND OF THE DISCLOSURE

### Technical Field of the Disclosure

The present embodiment relates generally to methods for improving mechanical properties of mycelium, and more particularly, to a method for improving abrasion resistance of the mycelium and determining reduction of the coefficient of friction for improving the abrasion resistance of the mycelium.

### Description of the Related Art

Mycelium has emerged as a versatile biomaterial with a variety of mechanical and physical uses. One such manifestation of mycelium is as a textile such as in thin sheets used in the fabrication of finished goods such as shoes, bags, clothing, etc. In order for mycelium to be useful in these applications, it must be processed so as to embody several mechanical properties including but not limited to abrasion resistance, finish adhesion, colorfastness, crocking, and dye transfer.

Several methods have been developed to improve the mechanical properties of the mycelium. Among these methods, reduction of coefficient of friction of mycelium is a very efficient and reliable way to promote abrasion resistance, colorfastness to crocking, dye transfer as well as other attributes. FIG. 1 shows a microscopic view of a schematic representation of friction, illustrating two rough surfaces S1, S2 coming into contact with one another to increase the coefficient of friction. The contact of rough surfaces creates areas that are readily abraded or removed by such roughness.

One common technique implemented for reducing the coefficient of friction of a material is to make the surface of that material smoother. Even though many materials can be smoothed so as to reduce their coefficient of friction, mycelium material does not benefit from this action by demonstrating improved resistance to abrasion under a given amount of force. This is because, the mycelium is a soft biomaterial composed primarily of the polymer chitin along with various proteins which are readily abraded by only several tons of force from other soft materials such as cotton, linen, or mycelium itself. Also, this abrasion process does not result in a smoothing of the surface roughness of the material. As such, mycelium's effectiveness in applications where abrasion resistance is desired is limited. Since mycelium is a soft, naturally rough material with no brittle-type breakage or cleavage upon cutting, it is not readily polished via typical means used for hard materials, such as with sandpaper, slurries, or other abrasives. Such abrasive processes readily remove large (>10 μm diameter) particles of the material from the mycelium surface non-uniformly thereby resulting in an even rougher surface. Further, such abrasive processes do not provide the quantity of material that will be abraded off from any mycelium product.

Another method to improve the abrasion resistance of the mycelium includes applying different coatings on mycelium surface for creating water resistance, abrasion resistance or to otherwise enhance the surface properties. Common coatings, such as polyurethanes, require additional cost and processing while simultaneously detracting from the natural quality of the mycelium material and eliminating its biodegradability. Further, applying coatings on the mycelium surface is a method that has major drawbacks which have not been addressed yet. Similarly, a novel means of applying a coating to mycelium has yet to be developed due to the difficulty in making typical coating complexes adhere to the mycelium, due to its different chemistry and functional agreement with common coatings such as polyurethanes and acrylics.

Further, certain conventional methods for reducing the coefficient of friction, such as through cold-pressing, hot-pressing or sandpaper grinding and polishing have limited effect and may severely abrade the material. Such subtractive processes will remove mycelium from the surface of the material, but will fail to result in a surface that is any smoother than before the processes were attempted.

Therefore, there is a need for an efficient and reliable method for enhancing mechanical properties of a mycelium material. Such a method would reduce the coefficient of friction of the mycelium material to enhance abrasion resistance of a mycelium surface. Further, such a method would enhance the abrasion resistance of the mycelium surface without removing so many particles from the mycelium surface. Such a method would not destroy the natural quality and the biodegradability of the mycelium material. Similarly, there is a need for a method that would smooth the surface of the mycelium by applying a short amount of force on the mycelium material. Such a method would provide the quantity of mycelium material that would be abraded from any mycelium product. Moreover, such a needed method would not require additional cost and processing. The present embodiment accomplishes these objectives.

### SUMMARY OF THE INVENTION

To minimize the limitations found in the prior art, and to minimize other limitations that will be apparent upon the reading of the specification, the preferred embodiment of the present invention provides a method for reducing and determining a coefficient of friction of a microstructure of a mycelium (or mycelium composite) for improving a plurality of mechanical properties of the mycelium surface.

In the preferred embodiment, the mycelium includes a first mycelium layer having a first surface. The first mycelium layer is contacted with an apparatus which applies both pressure and kinetic friction forces. The combination of forces comprises a directional force that is applied along a vector less than perpendicular and also not completely parallel to the first mycelium surface. The aforementioned apparatus applies a simultaneous combination of a frictional force along the surface, and a pressure force normal to the mycelium. The resulting effect on the mycelium microstructure is abrasion that causes smoothing of the mycelium surface. Unlike typical methods of abrasive polishing, the surface material of the mycelium is not removed, but is rather densified and slicked through the combination of mycelial filaments and the plasticizing agents already present in the mycelium at the time the frictional and pressure forces are applied; thus, altering the microstructure of the mycelium surface. The smoothing of the mycelium surface decreases the coefficient of friction and enhances the abrasion resistance of the mycelium microstructure. This reduction of the coefficient of friction improves the plurality of mechanical properties of the mycelium including but not limited to abrasion resistance, finish adhesion, colorfastness, crocking, and dye transfer. The preferred method measures the quantity of coefficient of friction reduced through smoothing of the mycelium surface, utilizing a tilt angle mechanism.

In the tilt angle mechanism, a first mycelium piece is flattened and attached to a plane surface. A second mycelium piece is then loosely placed on a top portion of the first mycelium piece. The plane/tilting surface is tilted utilizing a tilt force until the second mycelium piece freely slides off the first mycelium piece. The quantity of coefficient of friction reduced through smoothing of the mycelium surface is determined by measuring an angle at which the second mycelium piece freely slides off the first mycelium piece. The coefficient of static friction is calculated utilizing the equation, μₛ=tan(θ), where μₛ is the calculated coefficient of friction and tan(θ) is the tangent of the angle at which the second piece of mycelium freely slips.

In one embodiment of the present invention, the mycelium samples are grown from fungal spores to a uniform thickness of approximately 0.9 to 2.5 mm after drying and processing. The abrasion resistance can be characterized using a standard Martindale Abrasion Resistance tester using protocol ISO 12947-1:1998.

A first objective of the present invention is to provide a method for reducing the coefficient of friction of a mycelium.

A second objective of the present invention is to provide a method for quantifying the reduction in the coefficient of friction of a mycelium.

A third objective of the present invention is to provide a method for enhancing a plurality of mechanical properties of the mycelium.

A fourth objective of the present invention is to provide a method for improving an abrasion resistance of the mycelium by smoothing the microstructure of the mycelium.

A fifth objective of the present invention is to provide a method for calculating reduced quantity of coefficient of friction of a mycelium surface utilizing a tilt angle mechanism.

A sixth objective of the present invention is to provide a method that does not destroy the natural quality nor the biodegradability of the mycelium material.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 shows a schematic representation of friction, illustrating an existing method for increasing the coefficient of friction utilizing two rough surfaces;

FIG. 2 shows a block diagram of a method for determining a coefficient of friction and improving an abrasion resistance of a mycelium microstructure according to the preferred embodiment of the present invention;

FIG. 3 shows a flowchart for a method for determining the coefficient of friction of the mycelium microstructure according to the preferred embodiment of the present invention;

FIG. 4 shows a data chart, illustrating an improvement in abrasion resistance as measured by Martindale testing according to the preferred embodiment of the present invention;

FIG. 5 shows a data chart illustrating a reduction in mycelium coefficient of friction achieved through combination of pressure and light abrasion according to the preferred embodiment of the present invention;

FIG. 6A shows a non-burnished mycelium sample according to the preferred embodiment of the present invention;

FIG. 6B shows a burnished mycelium sample under Martindale testing according to the preferred embodiment of the present invention;

FIG. 7 shows a photograph of a close-up view of the abraded areas of the mycelium sample shown in FIG. 6B according to the preferred embodiment of the present invention;

FIG. 8A shows a photograph of a first mycelium piece utilized for a tilt-angle measurement of the coefficient of friction of the mycelium according to the preferred embodiment of the present invention;

FIG. 8B shows a photograph of a second mycelium piece respectively utilized for the tilt-angle measurement of the coefficient of friction of the mycelium according to the preferred embodiment of the present invention;

FIG. 9A shows a photograph of the first mycelium piece after burnishing in order to measure the coefficient of friction of the mycelium utilizing the tilt-angle measurement; and

FIG. 9B shows a photograph of the second mycelium piece after burnishing in order to measure the coefficient of friction of the mycelium utilizing the tilt-angle measurement.

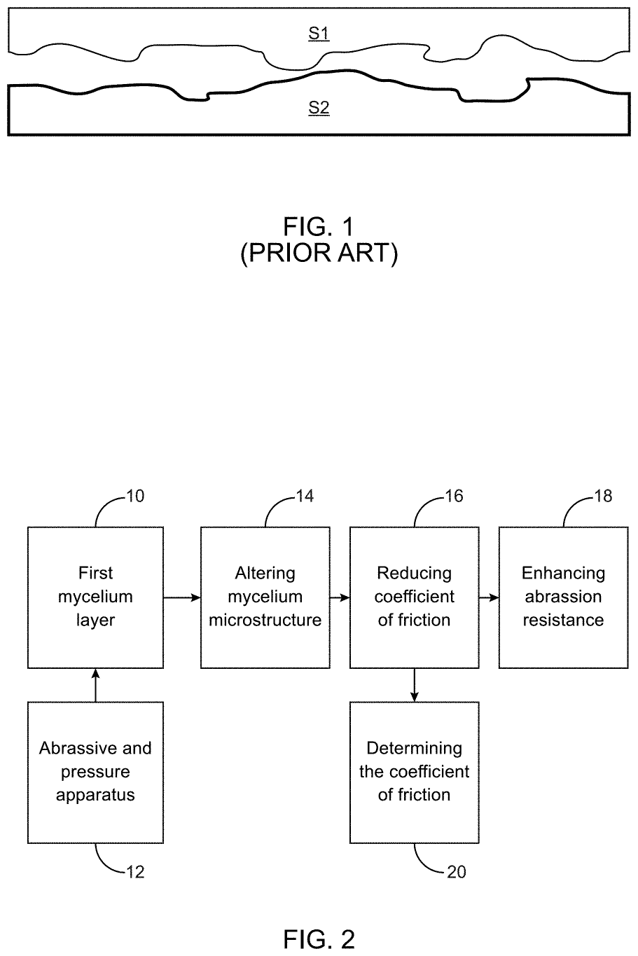

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

Referring to FIGS. 2-9B, a method for determining coefficient of friction of a microstructure of a mycelium for improving a plurality of mechanical properties is illustrated. As shown in FIG. 2, the mycelium includes a first mycelium layer 10. In one embodiment of the present invention, the mycelium samples are grown from fungal spores to a uniform thickness of approximately 0.9 to 2.5 mm after drying and processing. In another embodiment the samples are grown from Ganoderma spores. The first mycelium layer 10 is contacted with an abrasive and pressure apparatus 12 utilizing a directional force. The abrasive and pressure apparatus 12 applies a combination of abrasion and pressure simultaneously to the mycelium which causes smoothing of the mycelium surface thereby altering the microstructure of the mycelium as shown at block 14. The smoothing of the mycelium surface decreases the coefficient of friction as indicated at block 16 which in turn enhances the abrasion resistance of the mycelium microstructure. This reduction of the coefficient of friction improves a plurality of mechanical properties of the mycelium other than the abrasion resistance as shown at block 18. The plurality of mechanical properties including but not limited to tensile strength, tear strength, stitchability, colorfastness and dye transfer. The preferred method measures the quantity of coefficient of friction reduced through smoothing of the mycelium surface utilizing a tilt angle mechanism as shown at block 20.

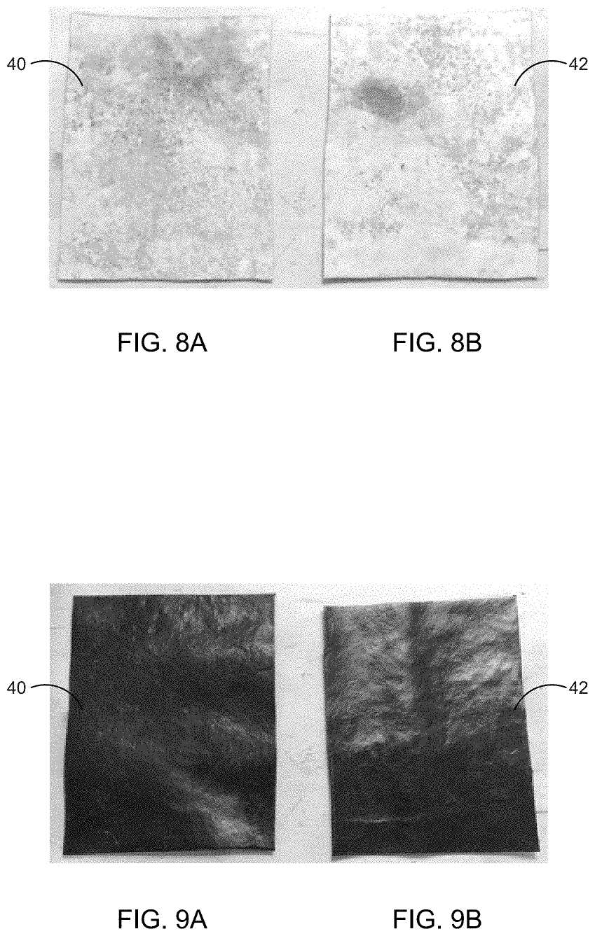

In the tilt angle mechanism, a first mycelium piece 40 (see FIG. 8A) is flattened. The first mycelium piece 40 is attached with a plane surface. A second mycelium piece 42 (see FIG. 8B) is then loosely placed on a top portion of the first mycelium piece 40. The plane surface is tilted utilizing a tilt force until the second mycelium piece 42 freely slides off the first mycelium piece 40. The quantity of coefficient of friction reduced through smoothing of the mycelium surface is determined by measuring an angle at which the second mycelium piece 42 freely slides off the first mycelium piece 40. The coefficient of static friction is calculated utilizing the equation, μₛ=tan(θ), where μₛ is the calculated coefficient of friction and ‘θ’ is the angle at which the second mycelium piece 42 freely slips. The aforementioned equation for determining the coefficient of friction is formulated as follows:

The force to overcome static friction, fₛ=f_{s max}=μₛ N, whereby μₛ is the coefficient of static friction and N is the force applied. Following this, we find that:

| | |
|---|---|
| ΣFₓ = m aₓ = 0 | ΣF_{y} = m a_{y} = 0 |
| mg sin(θ) − fₛ = 0 | N − mg cos(θ) = 0 |
| mg sin(θ) = μₛ = 0 | N = mg cos(θ) |

$\frac{sin ( θ )}{cos ( θ )} = tan ( θ ) = {μ}_{s}$

From the above equation, it is clear that, the coefficient of static friction, μₛ is equal to the tangent of the measured angle ‘tan(θ)’ where the second mycelium piece 42 freely slips. Thus, calculated coefficient of static friction provides how much material will abrade off from any mycelium product in everyday use. In practice the slip angle may preferably be at or about 23.1%. In other embodiments the slip angle is less than 30%, less than 40%, or less than 23.1%. In still other embodiments the slip angle is between 23.1% and 40%.

The preferred method enhances the mycelium's abrasion resistance (such as is measured with typical Martindale or Taber® apparatuses) and colorfastness to crocking (such as is measured with a Crockmeter™). The abrasive and pressure apparatus 12 including but not limited to a glaze-jack. In one embodiment of the present invention, the mycelium samples are grown to a uniform thicknesses of approximately 0.9 to 2.5 mm after drying and processing. The abrasion resistance can be characterized using a standard Martindale Abrasion Resistance tester using protocol ISO 12947-1:1998.

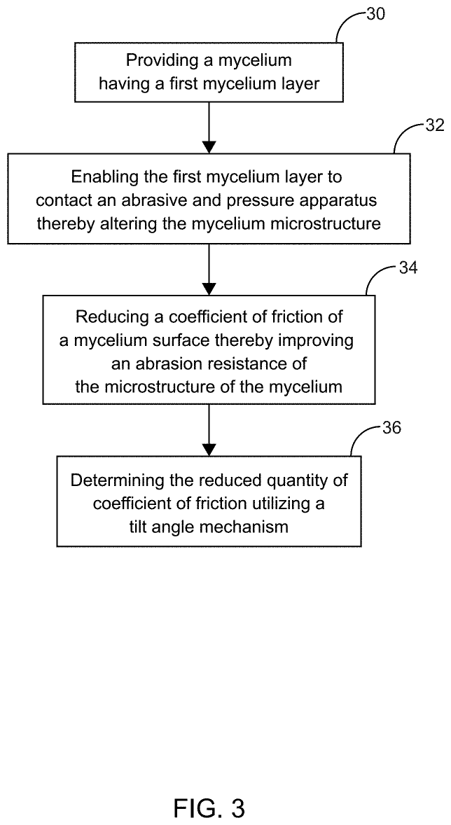

FIG. 3 shows a flowchart of a method for determining the coefficient of friction of the mycelium. The method commences by providing the mycelium having the first mycelium layer as indicated at block 30. Next, the first mycelium layer is enabled to contact with an abrasive and pressure apparatus thereby altering the mycelium microstructure as shown at block 32. Then, the coefficient of friction of the mycelium surface is reduced thereby improving the abrasion resistance of the microstructure of the mycelium as indicated at block 34. Finally, the coefficient of friction of the mycelium surface reduced through smoothing of the mycelium surface is determined as shown at block 36.

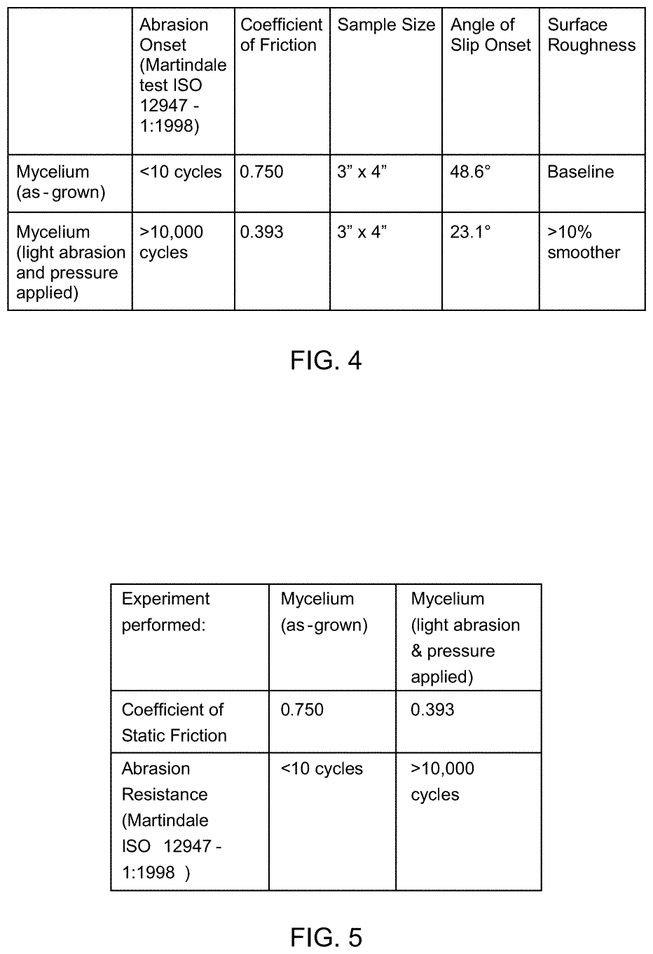

FIG. 4 shows an empirical data chart illustrating the improvement in abrasion resistance as measured by Martindale testing that correlates to a decrease in the coefficient of friction of the mycelium.

In one embodiment, the coefficient of static friction of the first mycelium layer 10 of the mycelium is less than 0.393 according to the tilt angle mechanism of the preferred embodiment. In other embodiments the coefficient of static friction is greater than 0.300. The microstructure of the first mycelium layer 10 is of at least 10% higher density than the remainder of the mycelium that has a density of at least 20 kg/m³ and 10% lower surface roughness than the remainder of the mycelium that has any surface roughness. In the preferred method of reducing the coefficient of static friction of mycelium through burnishing, the mycelium is abraded at a force between 10 and 10,000 N/(square foot) with a surface smoother than 600-grit sandpaper.

FIG. 5 shows another empirical data illustrating a reduction in the coefficient of friction of the mycelium achieved through combination of the pressure and the light abrasion.

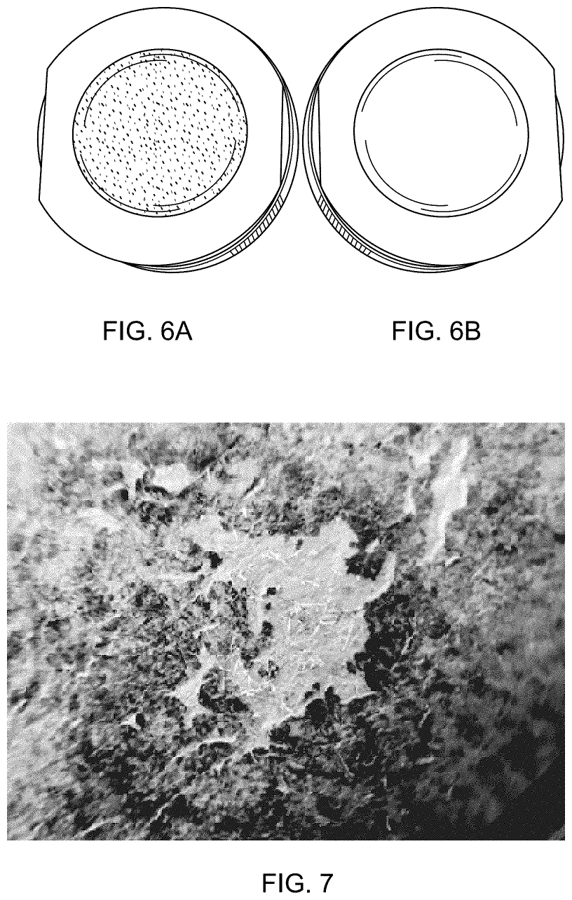

FIG. 6A shows a mycelium sample which is not burnished to reduce its coefficient of friction. FIG. 6B shows abrasion under Martindale testing (ISO 12947-1:1998) after 5,000 cycles with an onset of abrasion occurring in under 10 cycles.

FIG. 7 shows a close-up view of the abraded areas of the mycelium sample shown in FIG. 6B which was burnished to reduce the coefficient of friction. In this case no abrasion takes place after 10,000 cycles under the same Martindale testing.

FIG. 8A and FIG. 8B show a first mycelium piece 40 and a second mycelium piece 42 respectively utilized for the tilt-angle measurement of the coefficient of static friction of the mycelium according to the preferred embodiment of the present invention. The tilt angle of slip onset is the angle at which a first mycelium piece slides off a second mycelium piece.

FIG. 9A and FIG. 9B show the first mycelium piece 40 and the second mycelium piece 42 respectively after burnishing for measuring the coefficient of friction of the mycelium utilizing the tilt-angle measurement. As shown is FIG. 9A and FIG. 9B, there is a 1000× improvement in abrasion resistance over the mycelium samples shown in FIGS. 8A and 8B. In the preferred embodiment, a well burnished sample of mycelium will exhibit a glossiness and reflectance much higher than an unburnished sample. In one example the specular reflection is greater than 0.05, while in further examples the value is 0.075. Versus an unburnished sample, the burnished sample exhibits a reduction in diffusivity and in the scattering coefficient of the surface. Further, the hydrophobicity and contact angle for water increases post processing.

In one embodiment of the present invention, the coefficient of friction is reduced through simultaneously abrading the mycelium with a paper abrasive such as an extremely smooth high-grit sandpaper or standard white paper and applying pressure of greater than 10 N/(square foot). In this method, the coefficient of friction is reduced by 39.4% while the abrasion resistance is improved by a factor of 1000.

In another embodiment, the coefficient of friction can be reduced through abrading the mycelium with a hard material such as a glass object (for example: glass glazing jack) with pressure of greater than 10 N/(square foot) but not greater than 10,000 N/(square foot) applied. In this case, the process of abrasion, via the use of a kinetic friction) and the application of pressure are performed simultaneously thereby reducing the coefficient of friction and improving the abrasion resistance.

In yet another embodiment, the coefficient of friction can be reduced through simultaneously abrading the mycelium with a hard material such as metal and applying pressure of greater than 10 N/(square foot) but not greater than 10,000 N/(square foot) thereby reducing the coefficient of friction and improving the abrasion resistance.

In another embodiment of the present invention, the burnishing or abrasion of the mycelium is performed in water, oil, wax or some other liquid, emulsion, dispersion or soft solid. In this case, the burnishing requires at least 5N of force applied over a 1 square foot area.

In the preferred embodiment, the microstructural alteration of the mycelium surface occurs through the combination of mechanical processes and abrading under light pressure. In addition, the mycelium surface exhibits a luster and reflects light readily at a reflectance of greater than 10% even for dark colors such as black. Thus, the alteration of the mycelium microstructure as evidenced by the change in optical properties has marked a decrease of coefficient of static friction and results in multiple-order-of-magnitude improvement in abrasion resistance.

In one embodiment, the method of producing the improved mycelial material comprises providing the mycelium having a first mycelium layer; enabling the first mycelium layer to contact with an abrasive and pressure apparatus utilizing a directional force; applying abrasion and pressure simultaneously to the mycelium for smoothing a mycelium surface thereby altering the microstructure of the mycelium; reducing the coefficient of friction of the mycelium surface thereby improving the abrasion resistance of the microstructure of the mycelium; determining the reduced quantity of coefficient of friction utilizing a tilt angle mechanism, the coefficient of friction being determined by: flattening a first mycelium piece; attaching the first mycelium piece with a plane surface; placing a second mycelium piece loosely on a top portion of the first mycelium piece; tilting the plane surface utilizing a tilt force until the second mycelium piece freely slides off the first mycelium piece; and determining the quantity of coefficient of friction reduced through smoothing of the mycelium surface by measuring an angle at which the second mycelium piece freely slides off the first mycelium piece wherein the coefficient of static friction is calculated utilizing the equation, μₛ=tan(θ), where ‘θ’ is the angle at which the second piece of mycelium freely slips and μₛ is the calculated coefficient of friction.

The reduction of the coefficient of friction improves a plurality of mechanical properties of the mycelium including but not limited to tensile strength, tear strength, stitchability, the abrasion resistance, colorfastness and dye transfer.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A mycelium in contact with an apparatus, the mycelium apparatus combination comprising:
a. a first mycelium layer in contact with an apparatus that applies both pressure and kinetic friction forces along a vector less than perpendicular and not parallel to the upper surface so as to alter a microstructure of the mycelium;
b. wherein the coefficient of static friction of the first mycelium layer is less than 0.750;
c. whereby the coefficient of static friction is calculated by the equation μₛ=tan(θ), where μₛ is the calculated coefficient of friction tan(θ) is the tangent of the angle of slip onset, wherein said first mycelium piece is flattened and attached to a tilted surface, and wherein the second mycelium piece is placed loosely on top of the first mycelium piece; and
d. wherein the mycelium is completely biodegradable.

2. The mycelium apparatus combination according to claim 1 wherein the coefficient of friction is less than 0.400.

3. The mycelium apparatus combination according to claim 1 wherein the coefficient of friction is less than 0.300.

4. The mycelium apparatus combination according to claim 1 wherein the angle of slip onset is between 20.0% and 40.0%.

5. The mycelium apparatus combination according to claim 1 wherein the angle of slip onset is less than 30%.

6. The mycelium apparatus combination according to claim 1 wherein the angle of slip onset is less than 23.1%.

7. The mycelium apparatus combination according to claim 1 wherein the mycelium has a density of at least 20 kg/m³.

8. The mycelium apparatus combination according to claim 1 wherein the mycelium comprises a sheet of a uniform thickness of approximately 0.9-20 mm.

9. The mycelium apparatus combination according to claim 1 wherein the mycelium surface exhibits a luster or glossy sheen, and reflects light readily at a reflectance of greater than 10%.

10. The mycelium apparatus combination according to claim 1 wherein the mycelium exhibits a ratio of specular reflection to diffuse reflection of greater than 0.05.

11. The mycelium apparatus combination according to claim 1 wherein the mycelium is at least 1000 times as abrasion resistant as non-burnished mycelium.

12. A mycelium in contact with an apparatus, the mycelium apparatus combination comprising:
a. a first mycelium layer in contact with an apparatus that applies both pressure and kinetic friction forces along a vector less than perpendicular and not parallel to the upper surface so as to alter a microstructure of the mycelium;
b. wherein the mycelium exhibits a ratio of specular reflection to diffuse reflection of greater than 0.05;
c. whereby the coefficient of static friction is calculated by the equation μₛ=tan(θ), where μₛ is the calculated coefficient of friction tan(θ) is the tangent of the angle of slip onset, wherein said first mycelium piece is flattened and attached to a tilted surface, and wherein the second mycelium piece is placed loosely on top of the first mycelium piece; and
d. wherein the mycelium is completely biodegradable.

13. The mycelium apparatus combination according to claim 12 wherein the coefficient of friction is less than 0.750.

14. The mycelium apparatus combination according to claim 12 wherein the coefficient of friction is less than 0.300.

15. The mycelium apparatus combination according to claim 12 wherein the angle of slip onset is between 20.0% and 40.0%.

16. The mycelium apparatus combination according to claim 12 wherein the angle of slip onset is less than 30%.

17. The mycelium apparatus combination according to claim 12 wherein the angle of slip onset is less than 23.1%.

18. The mycelium apparatus combination according to claim 12 wherein the mycelium has a density of at least 20 kg/m³.

19. The mycelium apparatus combination according to claim 12 wherein the mycelium comprises a sheet of a uniform thickness of approximately 0.9-20 mm.

20. The mycelium apparatus combination according to claim 12 wherein the mycelium surface exhibits a luster or glossy sheen, and reflects light readily at a reflectance of greater than 10%.

21. The mycelium apparatus combination according to claim 12 wherein the mycelium is at least 1000 times as abrasion resistant as non-burnished mycelium.

22. A method for determining coefficient of friction of a microstructure of a mycelium, the method comprising the steps of:
a. providing the mycelium having a first mycelium layer;
b. enabling the first mycelium layer to contact with an abrasive and pressure apparatus utilizing a directional force of at least 10N per square foot, thereby altering the microstructure of the mycelium;
c. reducing the coefficient of friction of a mycelium surface thereby improving a plurality of mechanical properties of the microstructure of the mycelium; and
d. calculating the reduced quantity of coefficient of friction utilizing a tilt angle mechanism.

23. The method of claim 22 wherein the calculation of the coefficient of friction at step d) including the steps of:
a. providing a first mycelium piece and a second mycelium piece of the mycelium or mycelium composite;
b. flattening the first mycelium piece;
c. attaching the first mycelium piece to a plane surface;
d. placing the second mycelium piece loosely on a top portion of the first mycelium piece;
e. tilting the plane surface utilizing a tilt force until the second mycelium piece freely slides off the first mycelium piece; and
f. calculating the coefficient of friction by measuring an angle at which the second mycelium piece freely slides off the first mycelium piece, the wherein quantity of the coefficient of friction is calculated by the equation μₛ=tan(Θ), where ‘Θ’ is the angle at which the second mycelium piece freely slides off the first mycelium piece and ‘μₛ’ is the reduced quantity of coefficient of friction.

24. The method of claim 22 wherein the mycelium has a coefficient of friction of less than 0.300.

25. The method of claim 24 wherein the plurality of mechanical properties of the mycelium includes but not limited to abrasion resistance, finish adhesion, colorfastness, crocking, and dye transfer.

26. The method of claim 24 wherein the abrasive and pressure apparatus applies abrasion and pressure simultaneously for smoothing the mycelium surface thereby altering the microstructure of the mycelium.

27. A method for determining coefficient of friction of a microstructure of a mycelium, the method comprising the steps of:
a. providing the mycelium having a first mycelium layer;
b. enabling the first mycelium layer to contact with an abrasive and pressure apparatus utilizing a directional force thereby altering the microstructure of the mycelium;
c. reducing the coefficient of friction of a mycelium surface thereby improving an abrasion resistance of the microstructure of the mycelium;
d. determining the reduced quantity of coefficient of friction utilizing a tilt angle mechanism, the coefficient of friction being determined by:
i. flattening a first mycelium piece;
ii. attaching the first mycelium piece with a plane surface;
iii. placing a second mycelium piece loosely on a top portion of the first mycelium piece;
iv. tilting the plane surface utilizing a tilt force until the second mycelium piece freely slides off the first mycelium piece; and
v. determining the quantity of coefficient of friction by measuring an angle at which the second mycelium piece freely slides off the first mycelium piece, wherein the calculated coefficient of friction is given by the equation, μₛ=tan(θ), where ‘θ’ is the angle at which the second mycelium piece freely slips and μₛ is the calculated coefficient of friction.

28. The method of claim 27 wherein the abrasive and pressure apparatus applies a combination of abrasion and pressure to the mycelium for smoothing the mycelium surface and enhancing the abrasion resistance of the mycelium surface thereby reducing the coefficient of friction.

29. The method of claim 27 wherein said angle is less than 30%.

30. The method of claim 27 wherein the mycelium has a coefficient of friction of less than 0.300.
